(19) United States
(12) Patent Application Publication
(10) Pub. No.: US 2007/0258404 A1
(43) Pub. Date: Nov. 8, 2007

(54) Method for indicating and detecting transmission resource allocations in a multi-user communication system

(75) Inventors: Olav Tirkkonen, Helsinki (FI); Esa Malkamaki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/822,999

(22) Filed: Jul. 11, 2007

Related U.S. Application Data
(63) Continuation of application No. PCT/FI05/00012, filed on Jan. 11, 2005.

(51) Int. Cl. H04Q 7/00; H04J 1/00

(52) U.S. Cl. 370/329; 370/480

(57) ABSTRACT

The invention relates to a method for indicating the allocation of a set of transmission resources between user stations in a communication system comprising at least a control entity, a transceiver entity and at least one user stations. In the method in the control entity is determined the number of sharing user stations that share the set of transmission resources. In the control entity is determined a combination of transmission resource allocation sizes corresponding to the requirements of each the sharing user station. To the user stations is transmitted from the transceiver entity an allocation table wherein the sharing user stations are identified in an order corresponding to the transmission resource allocation sizes for each the sharing user station. To the user stations is transmitted from the transceiver entity a field identifying the combination of transmission resource allocation sizes.

### BACKGROUND OF THE INVENTION

1. Field of the Invention

The invention relates to multi-user communication systems. Particularly, the invention relates to indicating and detecting the transmission resources allocated for communication. The transmission resources are allocated for a plurality of user stations engaged in communication with a master station.

2. Description of the Related Art

Nowadays communication systems are used to transmit data associated with multiple different types of services. The communication is no longer merely associated with a single service with a uniform bandwidth requirement, which is invariant in time. The different types of services have different bandwidth requirements, which may also vary in short time intervals. One particular such type of service is packet data communication. Especially, a downlink channel for a given user may be used to transmit packets in bursts of varying length. It is important to be able to allocate to the user stations only the capacity needed. The transmission resource allocation to individual users must be indicated via a common channel. The transmission resource allocation information becomes more complicated and must be indicated frequently to the users due to the varying bandwidth requirement. This leads to increased consumption of common channel capacity.

Reference is now made to FIGS. 1A and 1B, which illustrate the indication of transmission resource allocation between a master station and a plurality of user stations in prior art. In FIG. 1A there is shown an alternative for presenting transmission resource allocation information that is carried on a common channel received by a number of user stations. On the common channel there are transmitted fields C1, C2, . . . , Cn. Generally, by a transmission resource is meant a channel or a channel portion that may be separately allocated for a given user station. There is one field for each transmission resource. The transmission resource may be, for example, a carrier frequency in Frequency Division Multiple Access (FDMA), a timeslot on a carrier frequency in Time Division Multiple Access (TDMA), a Code Division Multiple Access (CDMA) spreading code, a timeslot on a Code Division Multiple Access (CDMA) spreading code or a combination of at least two of a spreading code, a frequency and a timeslot. Each of the fields C1, C2, . . . , Cn is used to transmit a User Identification (UID). In FIG. 2B there is shown another alternative for presenting transmission resource allocation information. On the common channel there are transmitted bit vectors V1, V2, . . . , Vk. There is one bit vector for each user 1, 2, . . . ,k. Each bit vector comprises at least bits for each separately allocable transmission resource. The bit value 1 indicates that the transmission resource has been allocated for the user.

Next the concept of a transmission resource is illustrated by way of an example in Orthogonal Frequency Division Multiplexing (OFDM). OFDM may be used, for example, in a fixed medium or in radio- or micro-wave transmission. The OFDM is used, for example, in the HiperLAN2 and IEEE 802.11a Wireless Local Area Network (WLAN) standards. In the OFDM there is a carrier bandwidth, which is used to transmit data between a transmitter and a receiver. On the carrier bandwidth data is transmitted using a set of low bandwidth sub-carriers, which are mutually orthogonal. The orthogonality is achieved so that the sub-carrier frequencies are integer multiples of the inverse of symbol period time. In the OFDM the time domain is divided into symbol periods. The sub-carriers may be received using Fast Fourier Transform (FFT) even though the spectra of the sub-carriers overlap in the frequency domain.

Reference is now made to FIG. 2, which illustrates the structure of a carrier bandwidth 205 in frequency and time domains when the OFDM is used. In FIG. 2 the frequency domain is illustrated with y-axis 201 and the time domain is illustrated with x-axis 200. The time domain is divided into periods, which correspond to a symbol time 202. The frequency domain is split into sub-carrier bandwidths such as a sub-carrier bandwidth 204. A symbol time period on a given sub-carrier that is used to transmit data is referred to as a symbol. In FIG. 2 there is a symbol 206. The number of bits mapped to a symbol depends on the modulation used. For example, Quadrature Phase Shift Keying (QPSK) allows 2 bits to be mapped to a symbol, whereas 16-QAM (Quadrature Amplitude Modulation) allows 4 bits transmitted using a symbol. An OFDM symbol is a waveform with symbol time 202 and comprising entire carrier bandwidth 205, which is constructed from the symbols 206 on individual sub-carriers using, for example, the Inverse Fast Fourier Transform (IFFT).

When multiple users are sharing the resources used in a system applying OFDM modulation, the alternatives indicated above are possible. One may separate different users by TDMA, so that different OFDM symbols (or sequences of OFDM symbols) are allocated to different users. One may use spreading codes in the time domain, operating over multiple OFDM symbols, and these spreading codes may be allocated to different users using CDMA. Generalizing FDMA to OFDM modulation, individual sub-carriers may be allocated to different users, so that users are separated in frequency, implying Orthogonal Frequency Division Multiple Access (OFDMA). A minimum size transmission resource, which may be allocated to a given user, is a symbol, in other words, one sub-carrier during one OFDM symbol time. In practice a transmission resource may comprise a number of symbols 206, extending over multiple sub-carriers 204, multiple symbol times 202, or both. Also code division in the frequency domain is possible. In this method, spreading codes operate in the frequency domain as opposed to the time domain in normal CDMA. Users may be allocated different spreading codes. This is known as Multi-Carrier CDMA (MC-CDMA).

### SUMMARY OF THE INVENTION

The invention relates to a method for indicating the allocation of a set of transmission resources between user stations in a communication system comprising at least a control entity, a transceiver entity and at least one user station, the method comprises determining in the control entity the number of sharing user stations among the at least one user station that share the set of transmission resources; determining in the control entity a combination of transmission resource allocation sizes corresponding to the requirements of each sharing user station; transmitting from the transceiver entity to the at least one user station an allocation table wherein the sharing user stations are identified in an order corresponding to the transmission resource allocation sizes for each sharing user station; and transmitting from the transceiver entity to the at least one user station a field identifying the combination of transmission resource allocation sizes.

The invention relates also to a method for detecting the allocation of a set of transmission resources between user stations in a communication system comprising at least a control entity, a transceiver entity and at least one user station. The method comprises receiving at a first user station an allocation table wherein at least one user station is identified in an order corresponding to the transmission resource allocation sizes for each at least one user station; the first user station determining its position in the allocation table and the number of other identified user stations; receiving at the first user station a field identifying a combination of transmission resource allocation sizes; and determining in the first user station its transmission resources using the position, the number of other identified user stations and the combination of transmission resource allocation sizes.

The invention relates also to a system comprising at least one user station. The system further comprises: a control entity configured to determine the number of sharing user stations among the at least one user station that share a set of transmission resources, to determine a combination of transmission resource allocation sizes corresponding to the requirements of each the sharing user station; a transceiver entity configured to transmit to the at least one user stations an allocation table wherein the sharing user stations are identified in an order corresponding to the transmission resource allocation sizes for each sharing user station, and to transmit to the at least one user station a field identifying the combination of transmission resource allocation sizes.

The invention relates also to an electronic device for communicating via at least one transmission resource, the electronic device further comprising: a transceiver entity configured to receive an allocation table wherein at least one electronic device is identified in an order corresponding to the transmission resource allocation sizes for each at least one electronic device, to receive a field identifying a combination of transmission resource allocation sizes; a radio control entity configured to determine the position of the electronic device in the allocation table and the number of other identified electronic devices, to determine the transmission resources for the electronic device using the position, the number other identified electronic devices and the combination of transmission resource allocation sizes.

The invention relates also to a radio access subsystem for communicating with at least one user station, the subsystem further comprising: a control entity configured to determine the number of sharing user stations among the at least one user station that share a set of transmission resources, to determine a combination of transmission resource allocation sizes corresponding to the requirements of each sharing user station; a transceiver entity configured to transmit to the at least one user station an allocation table wherein the sharing user stations are identified in an order corresponding to the transmission resource allocation sizes for each sharing user station, and to transmit to the at least one user stations a field identifying the combination of transmission resource allocation sizes.

The invention relates also to a computer program comprising code adapted to perform the following steps when executed on a data-processing system: determining the number of sharing user stations that share a set of transmission resources; determining a combination of transmission resource allocation sizes corresponding to the requirements of each the sharing user station; transmitting to the user stations an allocation table wherein the sharing user stations are identified in an order corresponding to the transmission resource allocation sizes for each the sharing user station; and transmitting to the user stations a field identifying the combination of transmission resource allocation sizes.

The invention relates also to a computer program comprising code adapted to perform the following steps when executed on a data-processing system: receiving an allocation table wherein at least one user station is identified in an order corresponding to the transmission resource allocation sizes for each at least one user station; determining the position of a first user station in the allocation table and the number of other identified users; receiving a field identifying a combination of transmission resource allocation sizes; and determining it's the transmission resources of the first user station using the position, the number other identified user stations and the combination of transmission resource allocation sizes.

In one embodiment of the invention, the control entity is a radio network node and the user stations are mobile stations. The control entity may also be located in a base transceiver station or in a separate radio network node connected to the base transceiver station. In one embodiment of the invention, transceiver entity within the radio access subsystem is comprised in a base station and the control entity within the radio access subsystem is comprised in a radio network node connected to the base transceiver station, for example, in a radio network controller.

In one embodiment of the invention, the communication system is a Wireless Local Area Network (WLAN) and the electronic device is a WLAN terminal. In one embodiment of the invention, the communication system is a mobile communication system and the electronic device is a mobile station.

In one embodiment of the invention, a given transmission resource comprises at least one of a carrier frequency, a timeslot, a spreading code and a number of Orthogonal Frequency Division Multiplexing (OFDM) sub-carriers.

In one embodiment of the invention, a transmission resource comprises a number of adjacent Orthogonal Frequency Division Multiplexing (OFDM) sub-carriers. In one embodiment of the invention, a transmission resource comprises a number of evenly spaced Orthogonal Frequency Division Multiplexing (OFDM) sub-carriers. In one embodiment of the invention, a transmission resource comprises a number of evenly spaced clusters of adjacent Orthogonal Frequency Division Multiplexing (OFDM) sub-carriers. In one embodiment of the invention the transmission resource comprises a combination of at least two of a carrier frequency, a timeslot, a spreading code and an Orthogonal Frequency Division Multiplexing (OFDM) sub-carrier.

In one embodiment of the invention, the allocation table is transmitted on a common channel and the field is transmitted on a Dedicated Channel (DCH). In one embodiment of the invention, a dedicated channel comprises the set of transmission resources. In one embodiment of the invention, the dedicated channel comprises a number of separately allocable parts, which are handled as transmission resources according to the invention. In one embodiment of the invention, the transceiver entity is further configured to receive the allocation table on a common channel and the field on a dedicated channel.

In one embodiment of the invention, the computer program is stored on a computer readable medium. The computer readable medium may be a removable memory card, magnetic disk, optical disk or magnetic tape.

In one embodiment of the invention, the electronic device comprises is a mobile device, for example, a laptop computer, palmtop computer, mobile terminal or a personal digital assistant (PDA).

The benefits of the invention are related to more efficient use of a common channel by shortening entries in an allocation table transmitted to user stations. The information transmitted via a common channel for transmission resource allocation indication is reduced and made available for other usages.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A is a block diagram illustrating the indication of transmission resource allocation between a master station and a plurality of user stations on a common channel in prior art;

FIG. 1B is a block diagram illustrating the indication of transmission resource allocation between a master station and a plurality of user stations on a common channel in prior art;

FIG. 2 is a graph illustrating the structure of an OFDM carrier bandwidth in frequency and time domains in prior art;

FIG. 3 is a block diagram, which illustrates the indication of transmission resource allocations in one embodiment of the invention;

FIG. 4 is a block diagram, which illustrates how Part Allocation Information (PAI) bits carried on a dedicated channel header are used in the indication of transmission resource allocations for users in one embodiment of the invention;

FIG. 5A is a graph illustrating consecutive sub-carrier allocation to users on an OFDM carrier in one embodiment of the invention;

FIG. 5B is a graph illustrating evenly spaced sub-carrier allocation to users on an OFDM carrier in one embodiment of the invention;

FIG. 5C is a graph illustrating a hybrid sub-carrier allocation to users on an OFDM carrier in one embodiment of the invention;

FIG. 5D is a graph illustrating a sub-carrier cluster between two pilot tones in one embodiment of the invention;

FIG. 5E is a graph illustrating a sub-carrier cluster punctured by a pilot tone in one embodiment of the invention;

FIG. 6A is a block diagram illustrating a Mobile Station (MS), a Radio Access Network (RAN) comprising a Base Transceiver Station (BTS) and a Core Network (CN) in one embodiment of the invention;

FIG. 6B is a block diagram illustrating a Mobile Station (MS), a Radio Access Network (RAN), which comprises a Base Transceiver Station (BTS) and a radio network node, and a Core Network (CN) in one embodiment of the invention;

FIG. 7A is a flow chart depicting one embodiment of a method for transmission resource allocation indication in a communication system;

FIG. 7B is a flow chart depicting one embodiment of a method for transmission resource allocation detection in a communication system;

FIG. 8 is a graph illustrating multidimensional resource allocation in one embodiment of the invention; and

FIG. 9 is a block diagram illustrating an allocation table in multidimensional transmission resource allocation in one embodiment of the invention.

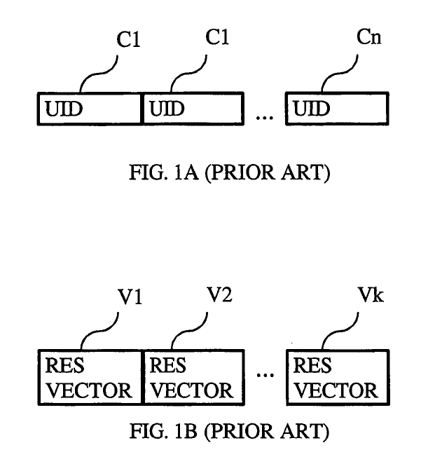

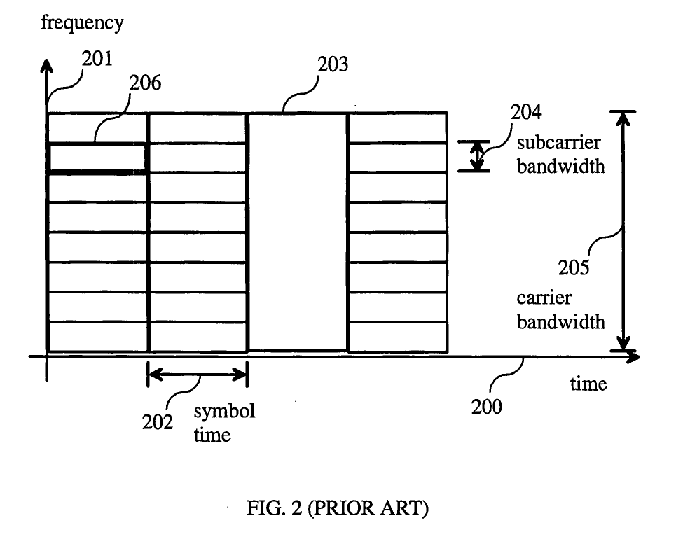

### DETAILED DESCRIPTION OF THE EMBODIMENTS

Reference will now be made in detail to the embodiments of the present invention, examples of which are illustrated in the accompanying drawings.

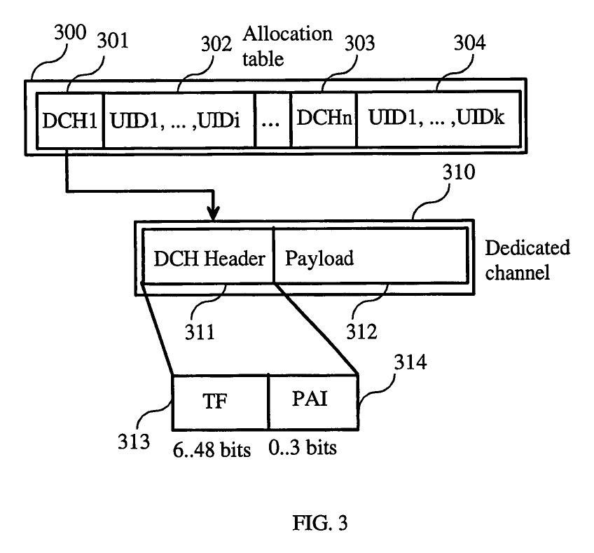

FIG. 3 is a block diagram, which illustrates the indication of transmission resource allocation in one embodiment of the invention. In FIG. 3 there is an allocation table 300, which is carried on a common channel (not shown). The common channel may be transmitted using a known transmission resource. A transmission resource may be, for example, a channel transmitted on a given frequency, a known frequency and time slot, a CDMA spreading code or a symbol within an OFDM symbol. In the Code Division Multiple Access (CDMA) the common channel is transmitted using a well-known spreading code. In one embodiment of the invention, the configuration of the common channel is informed to the users of the communication system using a beacon channel so that interested users may tune to the common channel. In the OFDM the common channel may comprise a number of specific sub-carriers on a symbol time period. The common channel is transmitted by a master station and is listened to by a number of user stations. In a radio system the master station is a single Base Transceiver Station (BTS) or a BTS comprising multiple transmitter base station repeaters. The base station serves a cell. In a radio system the user stations are, for example, Mobile Stations (MS). Each user station is identified using a User Identification (UID). In a communication system the user stations may be served by a number of master stations. In case there is a need to transmit data between the BTS and an MS, the MS is directed to a Dedicated Channel (DCH). In the OFDM a DCH may comprise, for example, a number of sub-carriers, which may change for one symbol time period to another. A DCH may be further divided to a number of individually allocable transmission resources. In the OFDM a transmission resource comprises at least one symbol, in CDMA, a transmission resource comprises at least one spreading code, and in TDMA, at least one time slot. A DCH may be divided, for example, to eight separately allocable transmission resources, in other words, sub-channels.

In FIG. 3 the allocation table also comprises a number of dedicated channel identifiers such as 301 and 303. DCH identifiers 301 and 303 are followed UID fields 302 and 304. A UID field comprises a number of UIDs. The UID field specifies the users, for which at least one transmission resource has been allocated from the DCH that is indicated in the DCH identifier immediately preceding the UID field. In FIG. 3 there is shown a DCH 310, which is pointed to by DCH identifier 301. Transmission resources on DCH 310 have been allocated to i number of users identified using UIDs UID1, . . . , UIDi. The UIDs in UID field 302 are listed on decreasing order depending on the number of transmission resources allocated for the users on DCH 310. The UID for the user for which the largest number of transmission resources have been allocated on DCH 310 is listed first in UID field 302, the UID for the user for which the second largest number of transmission resources have been allocated on DCH 310 is listed second in UID field 302 and so on.

In one embodiment of the invention, the UIDs in UID field 302 are listed in increasing order based on the number of transmission resources allocated for the users on DCH 310. Thus, in this embodiment the UID for the user for which the smallest number of transmission resources have been allocated is listed first. In one embodiment of the invention, the UIDs in UID field 302 are not listed straightforwardly based on an increasing or decreasing order of the resource allocations for the UIDs. Instead, the list of UIDs in UID field 302 is taken and permuted with an arbitrary predetermined permutation, which provides the respective order of resource allocation sizes for the UIDs in UID field 302.

On DCH 310 is transmitted first a self-decodable DCH header 311 and after that a payload 312. The payload comprises the actual transmission resources used to transmit user data. Self-decodable DCH header 311 further comprises a Transmission Format Indicator (TFI) field 313 and a Part Allocation Indication (PAI) field 314. The word part is used to refer to transmission resources, hence the acronym PAI. The length of TFI field 313 is between 6 and 48 bits and the length of PAI field 314 is between 0 to 3 bits, that is, PAI field 314 may be omitted. It should be noted that the number of bits in PAI field 314 and TFI field 313 herein is just one example and may vary in different embodiments of the invention. The number of bits in PAI field 314 and TFI field 313 may be arbitrary.

The transmission resources on a given DCH may be combined in a number of ways to form a number of transmission resource allocations. Hereinafter transmission resource allocations are also referred to as resource allocations for brevity. There are a number of transmission resources in a resource allocation. In other words, a resource allocation consists of at least one transmission resource. A resource allocation is always associated with a given user. The purpose of the PAI field is to indicate how transmission resources must be combined to form a given number of resource allocations. For given N number of users the PAI field determines, which particular size combination of resource allocations resulting in just N number of resource allocations must be selected. In one embodiment of the invention, the actual identities of transmission resources that are combined as resource allocations are not relevant and are not indicated in the PAI field. The resource allocations formed based on the PAI field value are ordered in decreasing size order, the largest first. The users are assigned the resource allocations based on the order they had on the UID field. If there is a PAI field, all active users need to receive and decode the DCH header, in order to know which part of the DCH is dedicated to the individual user.

Depending on the transmission methods, the amount of information related to transmission format indication that needs to be signaled varies. If the transmission format that one user uses is constant for the whole allocation period, a single transmission format of each user active in the allocation period has to be indicated. If one user is allowed to use multiple transmission formats, for example, due to link adaptation in the frequency domain (on a sub-carrier to sub-carrier, cluster to cluster or part to part basis), due to different interference or channel conditions on different spreading codes, or due to segmentation of coding blocks to the available resources, multiple transmission formats may need to be indicated for each user active in the allocation period. By default, the only user that needs to receive the user specific transmission format indication is the user whose format is indicated. Accordingly, all transmission format information to be indicated, part of it or none, of it may be transmitted in the self-decodable DCH Header 311, which needs to be decoded by all active users. The remaining transmission format information may be transmitted in a user specific self-decodable DCH header, or may be multiplexed into the data transmission. Alternatively, blind methods may be used to identify transmission formats, which may be used to decrease the number of transmission format bits.

Tentatively 6 bits per user are used to indicate the transmission format within the self-decodable DCH header 311. This would be sufficient to indicate one transmission format or a significant part of multiple formats for all active users. For at most eight active users, this means at most 8×6=48 bits. It should be noted that each active user participating in the allocation of resources must receive the PAI field. For each user there is a TFI field. Sizes of the TFI and PAI fields for certain numbers of users are indicated in Table 1.

TABLE 1

| | Users | | | | | | | |
|---|---|---|---|---|---|---|---|---|
| | 8 | 7 | 6 | 5 | 4 | 3 | 2 | 1 |
| Transmission format | 8 × 6 = 48 | 42 | 36 | 30 | 24 | 18 | 12 | 6 |
| indicator (TFI) bits | | | | | | | | |
| Part allocation indicator | 0 | 0 | 1 | 2 | 3 | 3 | 2 | 0 |
| (PAI) bits | | | | | | | | |
| TFI and PAI together | 48 | 42 | 37 | 32 | 27 | 21 | 14 | 6 |

In one embodiment of the invention, the PAI field is comprised in the allocation table transmitted on the common channel, but the TFI field is transmitted on the dedicated channels. In one embodiment of the invention, the TFI fields, or a number of most significant bits from each TFI field, for the active users are combined in a single packet, which is encoded as a single entity. The benefit of this embodiment over the embodiment where the TFI fields are encoded separately is that the TFI fields are protected with reduced overhead.

To protect the DCH header against errors, the TFI and PAI bits need to be protected by adding redundancy through forward error coding. In the disclosed DCH header structure, the TFI and PAI bits are coded together, to a constant number of coded bits, irrespective of the number of TFI and PAI bits.

The logic behind this is as follows. When selecting a minimum size for individually allocable transmission resources, two processes are balanced. With too small minimum size, overhead may grow considerably. With too large minimum size, the minimum packet size becomes too large. In a packet data system, small packets arising from IP headers, ARQ signaling and the carrying of Voice Over IP frames are frequent. Users close to the base station may employ codes with a high rate, of the order of ¾. However, for users close to the cell edge very strong codes, down to, for example, rate 1/6 coding may be used. This means that for a user at the cell edge, the minimum packet size in terms of coded bits is 4.5 times longer than the minimum packet size of a user close to the base station. When users at the cell edge are served, larger packets may be used, and fewer users need to be accommodated in one allocation period. Then the number of TFI bits is smaller. With a constant number of coded TFI+PAI bits, the protection of the TFI bits of users at the cell edge is higher. To put it more concisely: users that need strong coding for the data, get automatically strong coding for TFI bits, when the minimum packet size for different code rates is kept approximately constant.

The maximum number of TFI and PAI bits together is 48, while the minimum is 6. These should be encoded to a constant number of coded bits. For short codewords, block codes provide the best error protection. In a preferred embodiment, a Reed-Muller code of length n=128 is used. With such a code, k=64, 32 and 8 information bits may be encoded, with an error correcting capability of 7, 15 and 31 errors, respectively. The n=128, k=64 Reed-Muller code guarantees a block error rate <0.01 if the uncoded bit error rate is <0.02. For Rayleigh fading without diversity, this requires Eb/N0=8 dB. As the number of information bits is not 64, 32 or 8, a simple code, e.g. a repetition code may be first used to increase the number of bits to 64, 32 or 8. The proposed coding is illustrated in Table 2.

TABLE 2

| | Users | | | | | | | |
|---|---|---|---|---|---|---|---|---|
| | 8 | 7 | 6 | 5 | 4 | 3 | 2 | 1 |
| PAI + TFI | 48 | 42 | 37 | 32 | 27 | 21 | 14 | 6 |
| bits | | | | | | | | |
| Repetition | 64 | 64 | 64 | 32 | 32 | 32 | 32 | 8 |
| to | | | | | | | | |
| Code | (128, | (128, | (128, | (128, | (128, | (128, | (128, | (128, |
| RM(n, k) | 64) | 64) | 64) | 32) | 32) | 32) | 32) | 8) |

The Reed-Muller codes have the attractive property that they can be soft decoded using a simple trellis. From this it follows that the simple repetition gives some coding gain on top of the Reed-Muller code. The preferred repetition pattern is such that first the PAI bits are repeated, then the TFI bits of the users in the same order as they enter the allocation table. If a user errs in decoding the PAI bits, he is unable to locate his data. Thus stronger encoding of PAI improves the detection of all users. Similarly, if a user errs in decoding his TFI bits, he is unable to recover his data. Thus stronger encoding of the users with more information improves throughput, as the higher rate users err less frequently. Blind methods may be used to verify the correctness of the TFI bits. Using blind methods to verify the PAI bits is more involved, but may be used as well.

The DCH headers may be placed in any predefined place in the dedicated channel. In the example discussed above, the preferred embodiment is such that the 128 bits in the DCH header are placed on 64 QPSK symbols that are transmitted in the first OFDM symbol of the allocation period on a set of predefined sub-carriers that are next to pilot sub-carriers. Preferably these header sub-carriers are selected in a way that keeps the size of the 8 parts of payload sub-carriers the same.

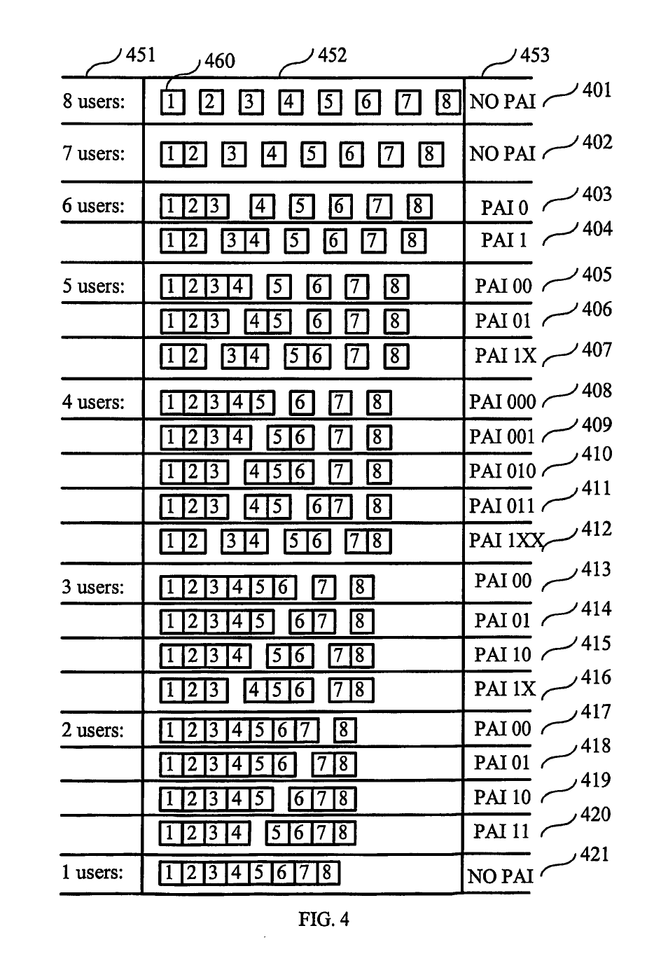

FIG. 4 is a block diagram, which illustrates how Part Allocation Information (PAI) bits carried on a dedicated channel header are used in indicating transmission resource allocations between users in one embodiment of the invention. In FIG. 4 there is a column 451, which indicates the number of users amongst which the transmission resources must be divided. There is also a column 452, which indicates for a given number of users the resource allocation size combinations logically possible. The actual assignation of an individual transmission resource to a resource allocation of particular size is irrelevant. There is also a column 453, which contains the PAI field values. Each PAI field value designates a particular resource allocation size combination for a given number of resource allocations. The number of individually allocable transmission resources such as, for example, transmission resource 460 is eight throughout FIG. 4. In column 452 separate boxes illustrate resource allocations consisting of a single transmission resource. Concatenated boxes illustrate resource allocations consisting of more than one transmission resource.

In FIG. 4 there are lines 401-421. Line 401 indicates the only one resource allocation size combination possible for 8 users. Line 402 indicates the only one resource allocation size combination possible for 7 users. It should be noted that which two of the transmission resources are combined to form a resource allocation is not considered relevant. Lines 403-404 indicate the two resource allocation size combinations possible for 6 users. Lines 405-407 indicate the three resource allocation size combinations possible for 5 users and so on. In the PAI fields on lines 407, 412 and 416 the least significant bits are not used and have no significance for the size combination selection. The users are assigned the resource allocations based on the order their UIDs had on the UID field. For example, if users with UIDs UID1, UID2 and UID3 are mentioned in this order on UID field 302 specifying user designations to DCH 310, DCH header 311 will provide a PAI field with a value, which tells how the eight available transmission resources must be allocated to these users. The UIDs in UID field 302 are ordered in decreasing order depending on the sizes of resource allocations for the users. Therefore, user for UID1 gets the largest size resource allocation, user for UID2 gets the next largest size resource allocation and user for UID3 gets the smallest size resource allocation. The value in PAI field 314 provides the precise size information for these resource allocations. If PAI field has value “01” the resource allocation size combination on line 414 is indicated. The users are assigned resource allocations on line 414 so that user with UID1 gets transmission resources 1,2,3,4 and 5, user with UID2 gets transmission resource 6 and 7 and user with UID3 gets transmission resource 8. By ordering the users in UID field 302 based on their resource allocation sizes, it is possible to indicate the resource allocation sizes for these users with just two bits in the PAI field. The number of users and transmission resources presented in FIG. 4 is just for illustrative purposes. The number of users and transmission resources way vary throughout different embodiments of the invention. In one embodiment of the invention the users are mobile stations in a mobile network.

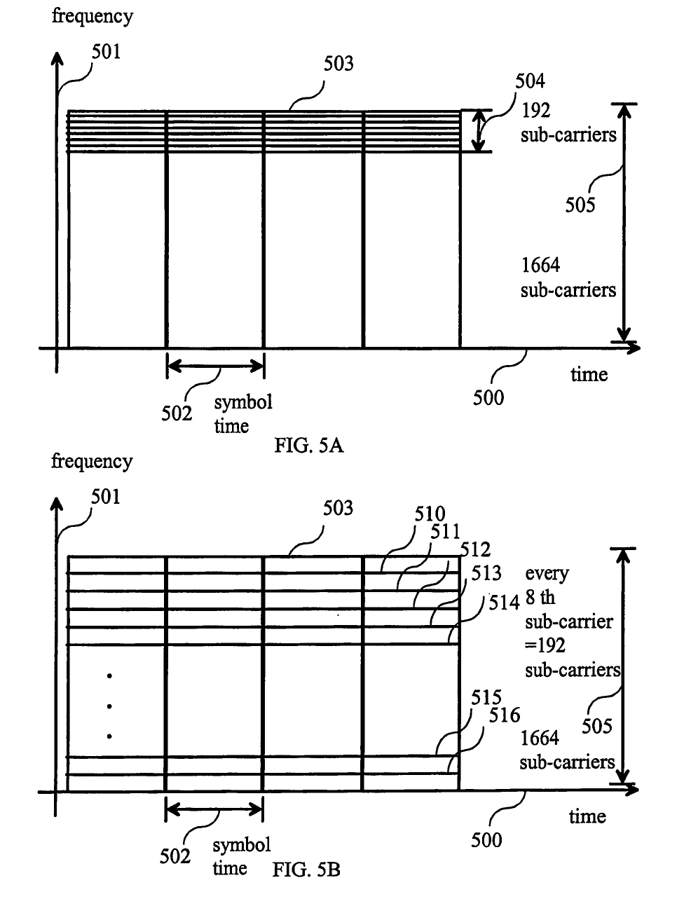

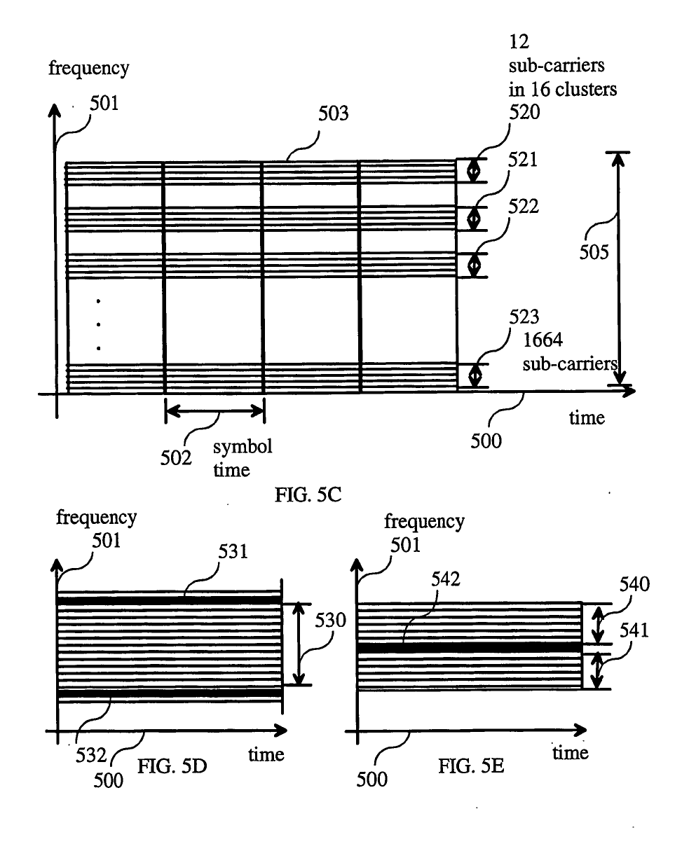

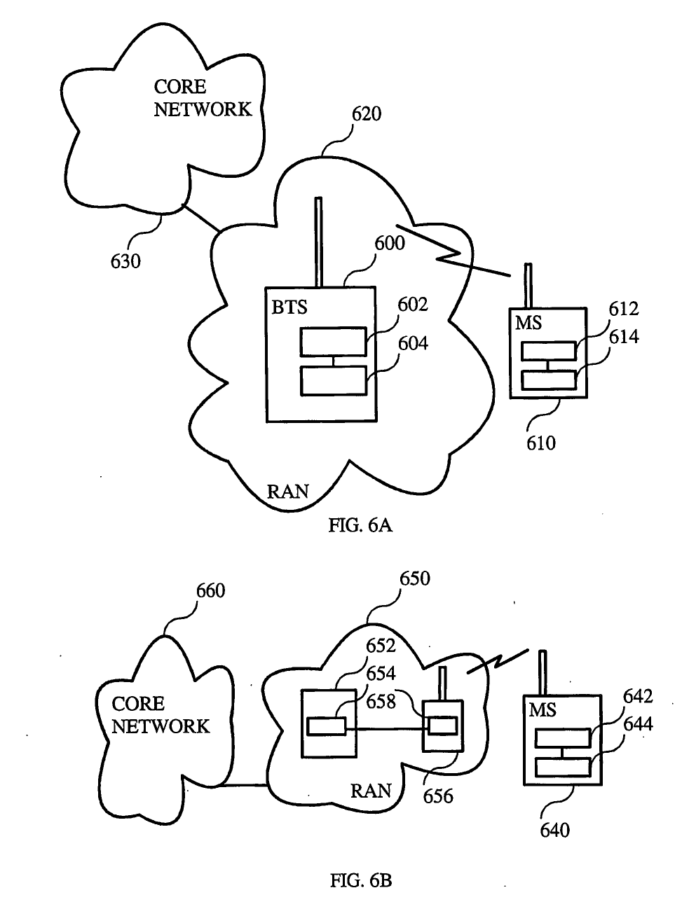

FIG. 5A is a graph illustrating consecutive sub-carrier allocation to users on an OFDM carrier in one embodiment of the invention. In FIG. 5A there is an axis 500, which illustrates time domain and an axis 501, which illustrates frequency domain. Symbol time period is illustrated with an arrow 502. There is also an arrow 505, which illustrates the bandwidth of altogether 1664 carriers. Every 13^{th} carrier is a pilot tone, which makes 128 pilot tones. The pilot tones are used to monitor channel conditions. In total we thus have 1664−128=1536 sub-carriers available for data transmission. For scheduling purposes, these may be divided to, for example, eight parts, so that the number of sub-carriers in one transmission resource available for data transmission is 1536/8=192. There is also an arrow 504, which illustrates consecutive sub-carrier allocation to form a transmission resource. The transmission resource comprises 192 sub-carriers in FIG. 5A.

FIG. 5B is a graph illustrating evenly spaced sub-carrier allocation to users on an OFDM carrier in one embodiment of the invention. In FIG. 5B there is an axis 500, which illustrates time domain and an axis 501, which illustrates frequency domain. Symbol time period is illustrated with an arrow 502. There is also an arrow 505, which illustrates the bandwidth of altogether 1664 carriers. Every 13^{th} carrier is a pilot tone, which makes 128 pilot tones. With eight transmission resources, the resulting number of sub-carriers available for data transmission in one transmission resource is again (1664−128)/8=192. In FIG. 5B every 8^{th} sub-carrier, not counting the pilot sub-carriers, is used to form a transmission resource. There are altogether 192 sub-carriers in a transmission resource. In FIG. 5B sub-carriers 510-516 are examples of evenly sub-carriers that are used in a given transmission resource.

FIG. 5C is a graph illustrating a hybrid sub-carrier allocation to users on an OFDM carrier in one embodiment of the invention. The hybrid sub-carrier allocation is a combination of solutions illustrated in FIGS. 5A and 5B. In hybrid allocation sub-carrier clusters are formed so that each cluster consists of adjacent sub-carriers. The clusters are evenly spaced. In a cluster there are, for example, 12 sub-carriers. There are, for example, 16 clusters. In one embodiment of the invention, 16 evenly spaced clusters are used to form a transmission resource. Between two adjacent clusters that belong to the same transmission resource there are seven clusters belonging to other transmission resources. In FIG. 5C arrows 520-523 indicate evenly spaced clusters of 12 sub-carriers. A cluster may be sandwiched between two pilot tones or it may be divided into two sub-clusters of 6 sub-carriers so that the sub-clusters have between them a pilot tone.

FIG. 5D is a graph illustrating a sub-carrier cluster between two pilot tones in one embodiment of the invention. In FIG. 5D there are pilot tones 531-532, which have between them a cluster 530 of sub-carriers.

FIG. 5E is a graph illustrating a sub-carrier cluster punctured by a pilot tone in one embodiment of the invention. In FIG. 5E there is a pilot tone 542, which is between sub-clusters 540 and 541.

In one embodiment of the invention, in addition to consecutive, evenly spaced and hybrid sub-carrier allocations, pseudorandom sub-carrier allocations are utilized. In pseudorandom sub-carrier allocation the sub-carriers belonging to an allocable resource are not necessarily consecutive or evenly spaced, but the spacing from one carrier to another may vary in a pseudorandom fashion.

FIG. 6A is a block diagram illustrating a Mobile Station (MS), a Radio Access Network (RAN) comprising a Base Transceiver Station (BTS) and a Core Network (CN) in one embodiment of the invention. In FIG. 6A there is a mobile station 610. Mobile Station (MS) 610 comprises a radio transceiver entity 612 and a radio control entity 614. Radio control entity 614 processes the allocation table information received to MS 610, requests radio transceiver entity 612 to tune to given DCHs, checks the TFI and PAI fields in DCH headers and causes radio transceiver entity 612 to use correct transmission resources that have been allocated for MS 610. Generally, radio control entity 614 performs all kinds of tasks related to the use of radio channels. In FIG. 6A there is also a Base Transceiver Station (BTS) 600, which comprises a radio transceiver entity 602 and a radio control entity 604. Radio control entity 604 is responsible for providing allocation table and DCH header information to be transmitted by radio transceiver entity 602. In one embodiment of the invention, radio control entity 604 is also responsible for allocating transmission resources for different mobile stations in its service area based on, for example, transmission resource scheduling performed by BTS 600. The scheduling is based on, for example, the downlink packet traffic volume for each mobile station.

FIG. 6B is a block diagram illustrating a Mobile Station (MS), a Radio Access Network (RAN), which comprises a Base Transceiver Station (BTS) and a radio network node, and a Core Network (CN) in one embodiment of the invention. In FIG. 6B there is a mobile station 640. Mobile Station (MS) 640 comprises a radio transceiver entity 642 and a radio control entity 644. The function of radio transceiver entity 642 and a radio control entity 644 is similar to FIG. 6A. In FIG. 6B there is a Radio Access Network (RAN) 650. In RAN 650 there is also a Base Transceiver Station (BTS) 656, which comprises at least a radio transceiver entity 658. There is also a radio network node 652 connected to BTS 656, which comprises a radio control entity 654, which performs radio transmission control in behalf of a number of BTSes. Radio control entity 654 is responsible for providing allocation table and DCH header information to be transmitted by radio transceiver entity 602 in BTS 656. In one embodiment of the invention, radio control entity 654 is also responsible for allocating and de-allocating transmission resources for different mobile stations in the service areas of a number of BTSes based on, for example, transmission resource scheduling performed by radio network node 652. In one embodiment of the invention, radio network node 652 performs downlink data traffic scheduling on behalf of a number of BTSes. In FIG. 6B there is also a Core Network (CN) 660 connected to RAN 650. In CN there is at least one CN node (not shown) connected either directly to BTS 656 or via radio network node 652.

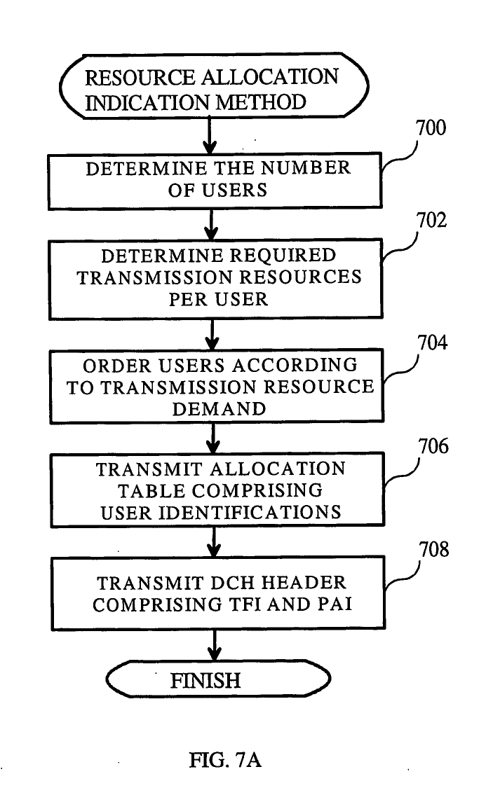

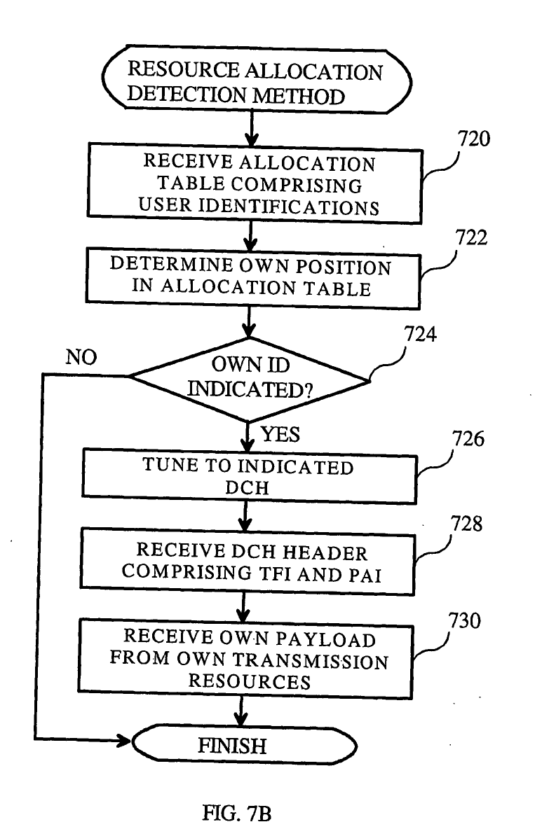

FIG. 7A is a flow chart depicting one embodiment of a method for transmission resource allocation indication in a communication system. The communication system is as illustrated in FIG. 6A or 6B. The structure of the bandwidth used in the communication between a BTS and a number of mobile stations is as illustrated in FIG. 5A, 5B or 5C. The structure of the information transmitted on a common channel and the DCHs between the BTS and the mobile stations are according to FIG. 3.

At step 700 a radio control entity in a radio access network determines the number of users that must be served using a given set of transmission resources available. A transmission resource may comprise, for example, a given set of OFDM sub-carriers for a symbol period time such as symbol time 502 in FIGS. 5A-5C. The set of transmission resources may comprise, for example, all the OFDM sub-carrier sets used for downlink communication from a BTS to the mobile stations in its area during symbol time 502. These OFDM sub-carrier sets may form a single DCH. Thus, there may be some extra OFDM sub-carriers used for the transmission of DCH header information. The number of users that must be served is the number of users, for which downlink traffic is scheduled for transmission during symbol time 502. In order to determine the number of users, the radio control entity performs the downlink traffic scheduling, for example, downlink packet or frame scheduling. For example, let us assume that there are three users for which downlink traffic is scheduled for transmission during symbol time 502.

At step 702 the radio control entity also determines, for example, using the scheduling the number of required transmission resources for each of the three users, that is, the resource allocation sizes for these users. Let us assume that a third user requires five transmission resources, a second user two transmission resources and a first user one transmission resource.

At step 704 the radio control entity orders the users according to transmission resource demand. Therefore, the third user is placed first, the second user is placed second and the first user is placed third on a list.

At step 706 the radio control entity forms an allocation table to be transmitted on a common channel. The allocation table structure is according to allocation table 300 in FIG. 3. The DCH identifier 301 is set to contain an identifier for a DCH that comprises the transmission resources shared between the first, the second and the third user. The UID field 302 is set to contain the UIDs for the first, the second and the third user. Thereupon, at least the DCH identifier field 301 and UID field 302 from the allocation table are transmitted on a common channel by a radio transceiver connected to the radio control entity.

At step 708 the radio control entity forms the DCH header, which is according to DCH header 311 in FIG. 3. TFI field 313 is set to the value corresponding to the selected transmission format. The PAI field 314 is set to value corresponding to the resource allocation sizes determined at step 702 by the radio control entity. In this case PAI field 314 is set to value “01”, which corresponds to row 414 in FIG. 4. This means, when interpreted together with the aforementioned ordering of the three users in UID field 302, that the third user gets five transmission resources, the second user two transmission resources and the first user one transmission resource. Thereupon, the DCH header 311 is transmitted on the DCH by the radio transceiver connected to the radio control entity.

FIG. 7B is a flow chart depicting one embodiment of a method for transmission resource allocation detection in a communication system. The communication system is as illustrated in FIG. 6A or 6B. The structure of the bandwidth used in the communication between a BTS and a number of mobile stations is as illustrated in FIG. 5A, 5B or 5C. The structure of the information transmitted on a common channel and the DCHS between the BTS and the mobile stations are according to FIG. 3. The common channel and the DCH are transmitted as described in association with FIG. 7A.

At step 720 a mobile station, for example, such as mobile stations 610 and 640 in FIGS. 6A and 6B, receives a common channel using a radio transceiver entity, on which at least part of an allocation table is transmitted by a BTS. The mobile station detects its own UID in UID field 302. The mobile station stores the DCH identifier carried in DCH identifier field 301 in its memory (not shown).

At step 722 the radio control entity in the mobile station checks the position of its UID in UID field 301 in relation to other UIDs, if its UID is present. If no transmission resources are allocated for the mobile station, its UID may be missing from UID field 301. Let us consider the case of the mobile station for the first user that was introduced in FIG. 7A. The mobile station determines that the UID for the first user is the third UID in UID field 301.

At step 724 the radio control entity in the mobile station checks if its user UID was indicated in the UID field 301. If it was indicated, the method continues at step 726, otherwise the method ends and the mobile station resumes the monitoring of the common channel subsequently.

At step 726 the radio control entity in the mobile station tunes to the DCH identified by the DCH identifier that was stored in the mobile station at step 720. The radio transceiver entity in the mobile station receives DCH header 311 and provides DCH header 311 field values to the radio control entity. Using the value in PAI field 313 the radio control entity determines the combination of resource allocation sizes used on the DCH. Using the value in TFI field the radio control entity determines the transmission format used on the DCH. Let us assume that the value in PAI field is “01”, which indicates the resource allocation sizes provided in column 452, line 414 on FIG. 4. The first resource allocation has the size of five transmission resources, the second two and the third one. In the case of the first user the third resource allocation is designated to the mobile station since the UID for the mobile station was the third UID in the UID field 302. Therefore, the resource allocation consisting of the transmission resource “8” is assigned for the mobile station of the third user.

At step 728 the radio control entity in the mobile station instructs the radio transceiver entity to receive the information transmitted to the mobile station from the BTS using the transmission resources that have been allocated to the mobile station. In the case of the mobile station of the third user the radio transceiver receives the information on the transmission resource “8”.

It should be understood that the method of indicating user allocation disclosed is not restricted to OFDM. Any multi-carrier modulation (MC-CDMA, Kaiser MC-CDMA, variable spreading factor MC-CDMA filter banks, separate RF filters, chip-repetition CDMA with phase vectors, any of these with code division in time and so on), or any single-carrier modulation (TDMA, CDMA) or any wavelet transform or any combination of these may be applied. The main idea is that a set of transmission resources is divided into parts and these parts are allocated to users, and that the allocation of transmission resources to users is indicated by a list of users and a number of part allocation indicator bits, which use the order of the listed users and a predefined order of transmission resources to indicate the precise allocation of parts to users.

Similarly, the header structure is only exemplary. The main idea is that the part allocation indication and transmission format indication are encoded jointly to increase reliability, and that the reliability of PAI bits may be increased to be higher than the reliability of TFI bits, if resources allow. Any code (block, trellis, iterative) may be used to encode the PAI+TFI bits. The PAI and/or TFI bits may not be transmitted as a DCH header; they may equally well be transmitted in the allocation table.

The disclosed method does not restrict to downlink use of mobile communication channels. In uplink the allocation of dedicated channel resources is performed by the BTS, whereas the users transmit the DCH. Thus for uplink resource allocation, the PAI bits have to be transmitted on a common downlink channel in the allocation table, on other common channel resources, or on dedicated downlink channels.

The structure of the PAI may be generalized if the part allocation from one allocation period to another may change with the set of active users being constant. For this, a bit may be added to the allocation table entry, indicating whether there is a single or multiple PAI allocations. These PAIs that change from symbol to symbol within the allocation may be indicated by multiple DCH headers, but preferably with a single header. Recall that coding gain increases with increasing block length.

The PAI may be made more flexible by adding permutation bits to the PAI, which permutation bits indicate that the order of users in the allocation table is permuted before interpreting the PAI. This applies when the resource allocation covers multiple minimum allocation periods. For full generality, the number of permutations may become rather high, but a limited set of permutations is sufficient to reach a high degree of flexibility in the size of the allocation. Before considering permutations, however, the full capability of the PAI bits should be used. Recall that in the example above, the PAI bits for 5,4 and 3 users were not fully used. If we allow for multiple per allocation period, the use of the PAI bits as indicated in Tables 3, 4 and 5.

TABLE 3
5 users: 4 alternatives, 2 indicator bits (one additional alternative)

| | | User | | | | |
|---|---|---|---|---|---|---|
| | | 1 | 2 | 3 | 4 | 5 |
| PAI 00 | Parts | 1, 2, 3, 4 | 5 | 6 | 7 | 8 |
| PAI 01 | Parts | 1, 2, 3 | 4, 5 | 6 | 7 | 8 |
| PAI 10 | Parts | 1, 2 | 3, 4 | 5, 6 | 7 | 8 |
| PAI 11 | Parts | 1, 2 | 3 | 4 | 5, 6 | 7, 8 |

TABLE 4
4 users: 8 alternatives, 3 indicator bits (3 additional permutations)

| | PAI 000 | 001 | 010 | 011 | 100 | 101 | 110 | 111 |
|---|---|---|---|---|---|---|---|---|
| User | Parts | Parts | Parts | Parts | Parts | Parts | Parts | Parts |
| 1 | 1, 2, 3, 4, 5 | 1, 2, 3, 4 | 1, 2, 3 | 1, 2, 3 | 1, 2 | 1, 2 | 1, 2, 3 | 1, 2, 3 |
| 2 | 6 | 5, 6 | 4, 5, 6 | 4, 5 | 3, 4 | 3, 4, 5 | 4, 5 | 4 |
| 3 | 7 | 7 | 7 | 6, 7 | 5, 6 | 6, 7 | 6 | 5, 6 |
| 4 | 8 | 8 | 8 | 8 | 7, 8 | 8 | 7, 8 | 7, 8 |

TABLE 5
3 users: 5 alternatives, 3 indicator bits (3 additional permutations)

| | PAI | PAI | PAI | PAI | PAI | PAI | PAI | PAI |
|---|---|---|---|---|---|---|---|---|
| | 000 | 001 | 010 | 011 | 100 | 101 | 110 | 111 |
| User | Parts | Parts | Parts | Parts | Parts | Parts | Parts | Parts |
| 1 | 1, 2, 3, 4, | 1, 2, 3, | 1, 2, 3, 4 | 1, 2, 3, 4 | 1, 2, 3 | 1, 2, 3 | 1, 2 | 1, 2, 3, |
| | 5, 6 | 4, 5 | | | | | | 4, 5 |
| 2 | 7 | 6, 7 | 5, 6, 7 | 5, 6 | 4, 5, 6 | 4, 5 | 3, 4, 5 | 6 |
| 3 | 8 | 8 | 8 | 7, 8 | 7, 8 | 6, 7, 8 | 6, 7, 8 | 7, 8 |

With these additional permutations illustrated in Tables 3, 4 and 5, the potential of the multiple PAI bits are fully exploited, and almost all different rate allocations of between five and three users can be accommodated in a sequence of minimum allocation periods.

For six and seven users, one permutation bit would be sufficient to reach almost full flexibility of the size of the allocation. This single bit would indicate whether or not a cyclic permutation is applied to the order of users used in the previous allocation period, and the corresponding bit is called a Cyclic Permutation Indicator (CPI). To reach nearly full flexibility of allocation, a number of minimum allocation periods have to be allocated over. This number Iₘₐₓ is also tabulated, together with the total number bₜₒₜ of PAI+CPI bits over Iₘₐₓ symbols. The use of the CPI bit is illustrated in Table 6.

TABLE 6

| Users | Permutation | CPI | PAI + CPI | Iₘₐₓ | bₜₒₜ |
|---|---|---|---|---|---|
| 8 | No permutation needed | 0 | 0 | 0 | 0 |
| 7 | Cyclic permutation of users | 1 | 1 | 7 | 7 |
| | 1, 2, 3, 4, 5, 6, 7 | | | | |
| 6 | Cyclic permutation of user | 1 | 2 | 3 | 6 |
| | pairs (12) (34) (56) | | | | |
| 5 | No permutation needed | 0 | 2 | 2 | 4 |
| 4 | No permutation needed | 0 | 3 | 3 | 9 |
| 3 | No permutation needed | 0 | 3 | 3 | 9 |
| 2 | No permutation needed | 0 | 2 | 1 | 2 |
| 1 | No permutation possible | 0 | 0 | 0 | 0 |

TABLE 7

| | Users | | | | | | | |
|---|---|---|---|---|---|---|---|---|
| | 8 | 7 | 6 | 5 | 4 | 3 | 2 | 1 |
| bₜₒₜ + TFI | 48 | 49 | 42 | 34 | 33 | 27 | 14 | 6 |
| Repetition | 64 | 64 | 64 | 64 | 64 | 32 | 32 | 8 |
| to | | | | | | | | |
| Code | (128, | (128, | (128, | (128, | (128, | (128, | (128, | (128, |
| RM(n, k) | 64) | 64) | 64) | 64) | 64) | 32) | 32) | 8) |

If a symbol-to-symbol changing part allocation within an allocation period is adopted, the coding of the DCH header should be changed accordingly. With the total number of PAI and CPI bits tabulated above, the preferred coding schemes become as illustrated in Table 7.

Finally, if more freedom is required for mapping resources to users, the actual assignation of an individual transmission resource to a resource allocation of particular size becomes relevant. This may be required if optimized packet scheduling is applied, where the resources are allocated to users according to the channel quality of the users on the different resources. In the example of 8 resources treated in FIG. 4, this means that the order of mapping the resources 1-8 into the user part allocation blocks in column 452 becomes meaningful. Above, a restricted allocation has been considered, where the set of possibilities to allocate resources to users was restricted. Below, less restricted or completely un-restricted allocations are discussed.

The first step to restrict the allocation less is to increase the PAI field to indicate the starting point for the assignment of individual transmission resources to a resource allocation. The starting point of the assignment carries information for all allocations except those where the resources are divided into equal parts. The resources are divided into equal parts in eight user and single user allocations, and specific two and four user allocations (lines 420 and 412). For the other allocations, adding three Resource Permutation Bits (RPB) to indicate the starting point of the allocation add flexibility for packet scheduling.

In one embodiment of the invention, where resource allocation is completely un-restricted, multiple additional bits are needed in the PAI field. The PAI field may be divided into an Allocation Size Bits (ASB) field and a Resource Indication Bits (RIB) field. In this embodiment, the PAI fields as discussed in association with FIG. 4 consist of an ASB field, and a number of RIB fields may be added for increasing generality. As we shall see below, when optimizing the overhead, the roles of the ASB and RIB fields cannot however be separated.

Before addressing the problem of PAI for un-restricted allocations, binary indications of subsets should be designed. That is, if complete generality is strived for when assigning individual transmission resources to users, the subsets of the set of transmission resources should be indicated.

Above, the savings in overhead were due to two sources. The first is the use of the information hidden in the order of reporting users in the allocation table. The second was the use of restricted subsets of the set of transmission resources, i.e. if 8 transmission resources are to be allocated to six users as in line 404 of FIG. 4, the subset of three transmission resources allocated to the user 1 is restricted to be {1,2,3} and not a general subset. For un-restricted allocation, we have to indicate what the three transmission resources allocated to user 1 are, i.e. the selected subset has to be signaled.

In solutions according to the invention, the information given by the order of users in the allocation table is used to reduce the overhead of signaling subsets also in un-restricted or less restricted cases.
a) The most straightforward way is to identify explicitly the transmission resources allocated to all users for which more than a single transmission resource is allocated. Among the users that get a single transmission resource, an un-restricted allocation can be realized by permuting the one-resource users in the allocation table.
b) An alternative is to report the transmission resources of all users except user 1 (who gets most transmission resources).
c) The optimal way is to use the smaller of the overheads given by algorithms a) and b) depending on the number of users. Thus in FIG. 4, for 8-5 users (lines 401-407) method a) would be used, and for 4-1 users (lines 408-421), method b) would be used.

Next the problem of binary indication of subsets is addressed. This can be done in many ways, using more or less bits.
1) The simplest method is to indicate all elements in the subset by a transmission resource indicator. Thus if there are eight transmission resources, an indicator consists of three bits. In a solution according to the invention, transmission resource indicators are used only to the degree that is necessary to identify the allocation, using one of methods a), b), c). If there are seven users (line 402 in FIG. 4), using method a) or c), three bits are used to indicate the first transmission resource allocated to the first user, and three more bits are used to indicate the second transmission resource. For users 2-7, no transmission resources need to be indicated. This is in contrast to the second prior art method indicated above, where for each user, the allocated transmission resources would be indicated.
2) To reduce overhead, the fact may be used that after one transmission resource is indicated, the next transmission resource is chosen from a smaller number of alternatives. The most straightforward way to do this is to reduce the number of transmission resource indication bits when the number of alternatives has halved. For example, to specify un-restricted allocation in line 410 using method b) or c), five transmission resources have to be indicated. Four transmission resources can be indicated using three bits each. Then the fifth transmission resource is selected from the four remaining transmission resources, and this choice may be indicated with two bits.
3) A slightly more involved algorithm takes the reduced choice into account for each bit, and creates a joint subset indicator, where an individual Resource Indication Bit is not dedicated to the specific transmission resource, but the whole sequence of RIBs indicate the subset. One algorithm to realize this works as follows. To indicate an ordered set of m elements chosen from n transmission resources, the number of alternatives is a=n*(n−1)* . . . *(n−m+1). The number of bits required to indicate one of these alternatives is b=┌ log₂(a)┐, where ┌x┐ denotes the smallest integer greater or equal to x. The subset may then be indicated by the binary representation (with b bits) of the number y=r1+(r2−1)*n+(r3−1)*n*(n−1)+ . . . +(rm−1)*n*(n−1)* . . . *(n−m+2) where r1=1, . . . ,m indicates the place of transmission resource 1 in the ordered set of m elements, r2=1, . . . ,m−1 indicates the place of transmission resource 2 in the ordered set of m−1 elements (which is the set of m elements from which the transmission resource indicated by r1 is removed, and so on.
4) The least overhead is used when it is observed that the subsets of the set of transmission resources indicated to a single user need not be ordered. Thus when method a) is used, what needs to be indicated is the subset of m transmission resources out of n allocated to the first user, and the order of the transmission resources does not matter. Similarly when method b) is used, in many cases subsets of multiple transmission resources allocated to a user need to be reported, and the order of transmission resources for one user does not matter. When indicating a non-ordered subset of m transmission resources out of n, the number of alternatives is not given by a=n*(n−1)* . . . * (n−m+1) but by the binomial coefficient

$$( \begin{matrix}n \\ m\end{matrix} ) = \frac{a}{m !} .$$

Compared to alternative 3) the subset indication problem, however, becomes harder. For a fixed n, this problem may be solved offline using e.g. recursive methods, and a concrete algorithm may be implemented based on the offline calculations. As a simple example, consider the indication of a subset of m=2 transmission resources from the set S={1 2 3 4} of n=4 elements. There are

$$( \begin{matrix}4 \\ 2\end{matrix} ) = 6$$

alternatives (requiring three bits) as opposed to 4*3=12 alternatives (requiring four bits), if an ordered set is reported as in 3). As the order of the elements in the subset does not matter, we assume that the subset is ordered so that the first element is smaller than the second. The first element in the subset may thus be chosen from the m−n+1=3 first elements in S. If the first element is p, there are n−p=3 choices for the second element:
(1,2) (1,3) (1,4)
(2,3) (2,4)
(3,4)
   This may be used to order the possible subsets, so that a number between 1 and 6 indicates a specific subset.

Finally, the role of separate Allocation Size Bits in the PAI field needs to be addressed. In methods 1) and 2) above, ASBs are necessary. The Resource Indication Bits are fully (although inefficiently) used in these algorithms. In methods 3) and 4), however, the bits indicate the subsets jointly, and the number of alternative is typically not a power of 2. The PAI field may be more efficiently exploited if they are not divided into separate ASB and RIB parts. Thus the alternatives 3) and 4) split into two:

3s) and 4s) separate ASB and RIB

3j) and 4j) joint ASB and RIB.

As an example, consider the difference of 3s) and 3j) in the example treated in FIG. 4, when there are six users, and method c) (or a) is used to reduce overhead.

In alternative 3s), separate ASB and RIB are given in the PAI field. For PAI(ASB) 0 (line 403), nine bits are required to select one of the 8×7×6=336 possibilities for the three transmission resources allocated to user 1. For PAI(ASB) 1 (line 404), at least eleven bits are required to indicate the selection of one of 8×7×6×5=1680 combinations of four transmission resources to users 1 and 2.

In alternative 3j), eleven bits (2048 alternatives) are sufficient to indicate the choice between all 336+1680=2016 combinations for 6 users with ASB 0 or 1. Thus the PAI field for six users could have eleven bits, and no explicit ASB bits would be needed. The exact mapping from these eleven bits to an allocation would be given by first observing whether the binary number y given by the eleven bits is smaller or greater than 1680 (in base 10). In the former case, we have a size allocation of the kind indicated in line 404, and y would directly indicate the ordered set of four transmission resources, e.g. as specified when discussing method 3) above. The two first indicated transmission resources go to user 1, the two next to user 2. In the latter case, we have a size allocation of the kind indicated in line 403. We compute 2048-y which then indicates a subset of three transmission resources e.g. as specified above, and these go to user 1.

Comparing to having separate ASB and RIB in the PAI field, the joint method has the advantage that the PAI field would be of fixed length for all six-user allocations. With separate ASB and RIB, the length of RIB would depend on the ASB.

In Table 8, the total length of the PAI field required for the restricted method, the less restricted method with starting point reporting and RPB, as well as for the completely un-restricted allocation methods 3j) and 4j) are reported. Eight transmission resources are allocated to different number of users. For 3j) and 4j), method c) is used to minimize the overhead.

TABLE 8

| | Users | | | | | | | |
|---|---|---|---|---|---|---|---|---|
| | 8 | 7 | 6 | 5 | 4 | 3 | 2 | 1 |
| restricted | 0 | 0 | 1 | 2 | 3 | 2 | 2 | 0 |
| ASB + RPB | 0 | 3 | 4 | 5 | 6 | 5 | 5 | 0 |
| 3j) PAI | 0 | 6 | 11 | 15 | 16 | 14 | 12 | 0 |
| 4j) PAI | 0 | 5 | 9 | 12 | 13 | 11 | 8 | 0 |

Comparing to prior art, the overhead savings of the disclosed methods depend on the length of the UID field. For comparison, the total length of the UID and PAI (without coding and TFI) are reported in Table 9 assuming a 16-bit UID and 8 transmission resources to be allocated. The two first lines give the overhead of the firs and second kind of prior art discussed above. In the first kind of prior art, for each transmission resource, the user is indicated. The resulting overhead is 8×16=128 bits (+possible coding), irrespectively of the number of transmission resources allocated to a user. In the second kind of prior art, for each user the allocated transmission resources are indicated. This requires users×16 bits to indicate the active users+8×3 bits to indicate the 8 transmission resources. Then the numbers for the restricted approach discussed in detail above are given, where the transmission resources given to an individual user cannot be selected. Overhead savings compared to the two kinds of prior art are given. Next, the less restricted method with starting point is reported, and finally, the un-restricted methods 3j) and 4j) with algorithm c).

TABLE 9

| | Users | | | | | | | |
|---|---|---|---|---|---|---|---|---|
| | 8 | 7 | 6 | 5 | 4 | 3 | 2 | 1 |
| Prior art 1 | 128 | 128 | 128 | 128 | 128 | 128 | 128 | 128 |
| Prior art 2 | 152 | 136 | 120 | 104 | 88 | 72 | 56 | 40 |
| UID + PAI | 128 | 112 | 97 | 82 | 67 | 50 | 34 | 16 |
| (restricted) | | | | | | | | |
| Overh save 1 | 0% | 13% | 24% | 36% | 48% | 61% | 73% | 88% |
| Overh save 2 | 16% | 18% | 19% | 21% | 24% | 31% | 39% | 60% |
| UID + PAI | 128 | 115 | 100 | 85 | 70 | 53 | 37 | 16 |
| (start ind) | | | | | | | | |
| Overh save 1 | 0% | 10% | 22% | 34% | 45% | 59% | 71% | 88% |
| Overh save 2 | 16% | 15% | 17% | 18% | 29% | 26% | 34% | 60% |
| UID + PAI | 128 | 117 | 105 | 92 | 77 | 59 | 40 | 16 |
| 4j) | | | | | | | | |
| Overh save 1 | 0% | 9% | 18% | 28% | 40% | 54% | 69% | 88% |
| Overh save 2 | 16% | 14% | 13% | 12% | 13% | 18% | 29% | 60% |
| UID + PAI | 128 | 118 | 107 | 95 | 80 | 62 | 44 | 16 |
| 3j) | | | | | | | | |
| Overh save 1 | 0% | 8% | 16% | 26% | 38% | 52% | 66% | 88% |
| Overh save 2 | 16% | 13% | 11% | 9% | 9% | 14% | 21% | 60% |

Prior art method 1 is better than prior art method 2 for a large number of users, whereas for a small number of users, prior art method 2 is better than prior art method 1. The disclosed methods save overhead compared to both prior art methods for any number of users (except comparing to prior art method 1 with the maximum number of users). The savings are naturally largest in the restricted allocation case. The overhead savings from using 4j) instead of 3j) for an unrestricted allocation are small.

When a wide range of possible allocation sizes have to be handled, the disclosed method may be generalized to a multi-dimensional allocation method. This is particularly beneficial if the allocation problem is naturally multidimensional. Thus for example allocating groups of sub-carriers in multi-carrier modulation symbols (e.g. OFDM) has to be combined with allocations that change in time.

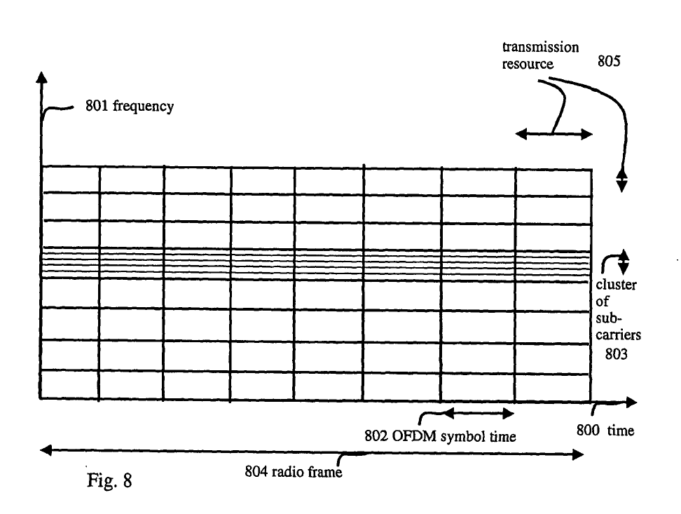

FIG. 8 is a graph illustrating multidimensional resource allocation in one embodiment of the invention. In FIG. 8 there is an OFDM radio frame 804 consisting of a number of OFDM symbols such as OFDM symbol 802. In a packet radio system, it is beneficial not to allocate transmission resources in the temporal dimension by a method of “until further notice”. Rather, the transmission resources allocated should have a finite extent in time. For this, the allocation period may be chosen to be a fixed period, which may be called a radio frame. Further, to accommodate widely diverse packet sizes, ranging from fractions of OFDM symbols (a number of sub-carriers during a number of OFDM symbols) to whole radio frames, the radio frame should be divided into a sufficiently large number of transmission resources. Thus the overall transmission capacity, represented by the overall bandwidth available for transmission, may be divided into transmission resources along multiple dimensions. In OFDM radio frame 804, the frequency is divided into eight frequency resources consisting of groups/clusters of sub-carriers such as cluster 803, and the temporal dimension is likewise divided into eight temporal resources, consisting of OFDM symbol times such as OFDM symbol 802. A transmission resource 805 then consists of a frequency resource during a temporal resource. Thus the resource pool in the frame 804 consists of 64 transmission resources, which have a natural two-dimensional description.

The disclosed method now immediately generalizes to a two-dimensional method to indicate resource allocations. First the temporal resources, that is, the eight OFDM symbols such as OFDM symbol 802 in the OFDM radio frame 804 are divided into from eight to one temporal parts. If the symbols in the OFDM radio frame 804 are divided into eight temporal parts, all of the parts consist of one OFDM symbol 802. If there is one part, that part consists of all eight symbols in the OFDM radio frame 804. Otherwise the symbols are divided into parts exactly as in FIG. 4. Thus if there are four parts, three Part Allocation Indicator bits are needed to identify the partition. These may be called Temporal Part Allocation Indicators (TPAI).

For each of the temporal parts, a frequency allocation is indicated using one of the methods described above. Either a restricted allocation may be used, where the frequency selectivity of the channel is not exploited, or a less restricted or un-restricted method may be used. To identify the allocation in frequency, a Frequency Part Allocation Indicator (FPAI) is required. For a downlink transmission, the disclosed two-dimensional method has the advantage that user that are not receiving in specified parts of the frame may keep their receivers shut off in a micro sleep function during that part of the frame.

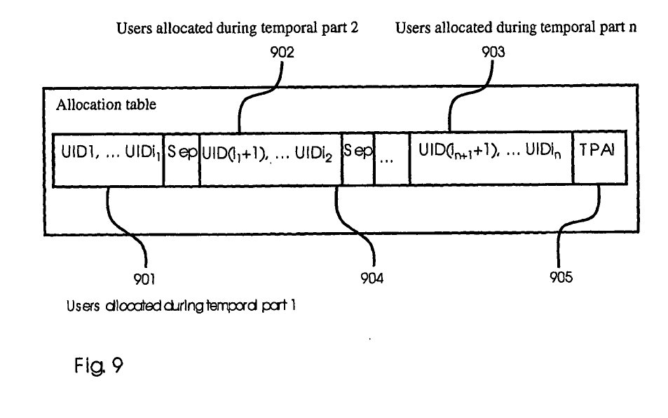

FIG. 9 is a block diagram illustrating an allocation table in multidimensional transmission resource allocation in one embodiment of the invention. An example of arranging the allocation table is in FIG. 9. The temporal dimension of the allocation period (frame) is divided into n parts. The frame is divided into altogether iₙ parts. Of these, i₁ share the first temporal part, i₂-i₁ the second part, and iₙ-iₙ₋₁ the n′th part. In a field 901 of the allocation table, the user identifiers of the users that the first temporal part is shared among are reported. In a field 902, the users of the second temporal part, and in a field 903, the users of the n′th part are indicated. Separator fields 904 separate parts 901, 902, 903 of the allocation table. Finally, in a specified location of the allocation table, a possible TPAI field 905 is transmitted. The possible FPAI fields pertaining to the respective temporal resources may be transmitted in the allocation table, or for downlink transmissions in a DCH header 311 as indicated in FIG. 3.

The disclosed use of the information hidden in the order of reporting users requires that nominally all resources must be allocated to some user. If it is not desired to allocate all resources, a dummy allocation to a dummy user may be performed. The UID for such a dummy user may be agreed to be a special kind of number, which may require less bits to signal. Alternatively, a field may be added in the allocation table indicating how many resources are allocated. The resources not allocated by the method disclosed herein may be reserved for allocation using other methods. For example, such resources may be allocated on an until-further-notice basis.

It is obvious to a person skilled in the art that with the advancement of technology, the basic idea of the invention may be implemented in various ways. The invention and its embodiments are thus not limited to the examples described above; instead they may vary within the scope of the claims.

1. A method for indicating the allocation of a set of transmission resources between user stations in a communication system comprising at least a control entity, a transceiver entity and at least one user station, the method comprising:
determining in said control entity the number of sharing user stations among said at least one user station that share said set of transmission resources;
determining in said control entity a combination of transmission resource allocation sizes corresponding to the requirements of each said sharing user station;
transmitting from said transceiver entity to said at least one user station an allocation table wherein said sharing user stations are identified in an order corresponding to the transmission resource allocation sizes for each said sharing user station; and
transmitting from said transceiver entity to said at least one user station a field identifying said combination of transmission resource allocation sizes.

2. The method according to claim 1, wherein said control entity is a radio network node and said user station is a mobile station.

3. The method according to claim 1, wherein said communication system is a wireless local area network.

4. The method according to claim 2, wherein said communication system is a mobile communication system.

5. The method according to claim 1, wherein said transmission resource comprises at least one of a carrier frequency, a timeslot, a spreading code and an Orthogonal Frequency Division Multiplexing (OFDM) sub-carrier.

6. The method according to claim 1, wherein said transmission resource comprises a combination of at least two of a carrier frequency, a timeslot, a spreading code and an Orthogonal Frequency Division Multiplexing (OFDM) sub-carrier.

7. The method according to claim 1, wherein a transmission resource comprises a number of adjacent Orthogonal Frequency Division Multiplexing (OFDM) sub-carriers.

8. The method according to claim 1, wherein a transmission resource comprises a number of evenly spaced Orthogonal Frequency Division Multiplexing (OFDM) sub-carriers.

9. The method according to claim 1, wherein a transmission resource comprises a number of evenly spaced clusters of adjacent Orthogonal Frequency Division Multiplexing (OFDM) sub-carriers.

10. The method according to claim 1, wherein said allocation table is transmitted on a common channel and said field is transmitted on a dedicated channel.

11. The method according to claim 1, wherein said a dedicated channel comprises said set of transmission resources.

12. A method for detecting the allocation of a set of transmission resources between user stations in a communication system comprising at least a control entity, a transceiver entity and at least one user station, the method comprising:
receiving at a first user station an allocation table wherein at least one user station is identified in an order corresponding to the transmission resource allocation sizes for each said at least one user station;
said first user station determining its position in said allocation table and the number of other identified user stations;
receiving at said first user station a field identifying a combination of transmission resource allocation sizes; and
determining in said first user station its transmission resources using said position, said number of other identified user stations and said combination of transmission resource allocation sizes.

13. The method according to claim 12, wherein said control entity is a radio network node and said at least one user station is a mobile station.

14. The method according to claim 12, wherein said communication system is a wireless local area network.

15. The method according to claim 12, wherein said communication system is a mobile communication system.

16. The method according to claim 12, wherein said transmission resource comprises at least one of a carrier frequency, a timeslot, a spreading code and an Orthogonal Frequency Division Multiplexing (OFDM) sub-carrier.

17. The method according to claim 12, wherein said transmission resource comprises a combination of at least two of a carrier frequency, a timeslot, a spreading code and an Orthogonal Frequency Division Multiplexing (OFDM) sub-carrier.

18. The method according to claim 12, wherein a transmission resource comprises a number of adjacent Orthogonal Frequency Division Multiplexing (OFDM) sub-carriers.

19. The method according to claim 12, wherein a transmission resource comprises a number of evenly spaced Orthogonal Frequency Division Multiplexing (OFDM) sub-carriers.

20. The method according to claim 12, wherein a transmission resource comprises a number of evenly spaced clusters of adjacent Orthogonal Frequency Division Multiplexing (OFDM) sub-carriers.

21. The method according to claim 12, wherein said allocation table is transmitted on a common channel and said field is transmitted on a dedicated channel.

22. The method according to claim 12, wherein said a dedicated channel comprises said set of transmission resources.

23. A system comprising at least one user station (610,640), the system further comprising:
a control entity (604,654) configured to determine the number of sharing user stations (610,640) that share a set of transmission resources (504), to determine a combination of transmission resource allocation sizes (452) corresponding to the requirements of each said sharing user station (610,640);
a transceiver entity (602,658) configured to transmit to said sharing user stations (610,640) an allocation table (300) wherein said sharing user stations (610,640) are identified in an order corresponding to the transmission resource allocation sizes for each said sharing user station (610,640), and
to transmit to said at least one user station (610,640) a field (314) identifying said combination of transmission resource allocation sizes (452).

24. The system according to claim 23, wherein said control entity is a radio network node and said at least one user station is a mobile station.

25. The system according to claim 23, wherein said communication system is a wireless local area network.

26. The system according to claim 23, wherein said communication system is a mobile communication system.

27. The system according to claim 23, wherein said transmission resource comprises at least one of a carrier frequency, a timeslot, a spreading code and an Orthogonal Frequency Division Multiplexing (OFDM) sub-carrier.

28. The system according to claim 23, wherein said transmission resource comprises a combination of at least two of a carrier frequency, a timeslot, a spreading code and an Orthogonal Frequency Division Multiplexing (OFDM) sub-carrier.

29. The system according to claim 23, wherein a transmission resource comprises a number of adjacent Orthogonal Frequency Division Multiplexing (OFDM) sub-carriers.

30. The system according to claim 23, wherein a transmission resource comprises a number of evenly spaced Orthogonal Frequency Division Multiplexing (OFDM) sub-carriers.

31. The system according to claim 23, wherein a transmission resource comprises a number of evenly spaced clusters of adjacent Orthogonal Frequency Division Multiplexing (OFDM) sub-carriers.

32. The system according to claim 23, wherein said allocation table is transmitted on a common channel and said field is transmitted on a dedicated channel.

33. The system according to claim 23, wherein said dedicated channel comprises said set of transmission resources.

34. An electronic device (610,640) for communicating via at least one transmission resource (504), the electronic device further comprising:
a transceiver entity (612,642) configured to receive an allocation table (300) wherein at least one electronic device (610,640) is identified in an order corresponding to the transmission resource allocation sizes for each at least one electronic device (610,640), to receive a field (314) identifying a combination of transmission resource allocation sizes (452);
a radio control entity (614,644) configured to determine the position of said electronic device (610,640) in said allocation table (300) and the number of other identified electronic devices (610,640), to determine the transmission resources for said electronic device (610,640) using said position, said number of other identified electronic devices (610,640) and said combination of transmission resource allocation sizes.

35. The electronic device according to claim 34, wherein said electronic device comprises a mobile station.

36. The electronic device according to claim 34, wherein said electronic device comprises a wireless local area network terminal.

37. The electronic device according to claim 34, wherein said mobile station comprises a cellular radio system mobile terminal.

38. The electronic device according to claim 34, wherein said transmission resource comprises at least one of a carrier frequency, a timeslot, a spreading code and an Orthogonal Frequency Division Multiplexing (OFDM) sub-carrier.

39. The electronic device according to claim 34, wherein said transmission resource comprises a combination of at least two of a carrier frequency, a timeslot, a spreading code and an Orthogonal Frequency Division Multiplexing (OFDM) sub-carrier.

40. The electronic device according to claim 34, wherein a transmission resource comprises a number of adjacent Orthogonal Frequency Division Multiplexing (OFDM) sub-carriers.

41. The electronic device according to claim 34, wherein a transmission resource comprises a number of evenly spaced Orthogonal Frequency Division Multiplexing (OFDM) sub-carriers.

42. The electronic device according to claim 34, wherein a transmission resource comprises a number of evenly spaced clusters of adjacent Orthogonal Frequency Division Multiplexing (OFDM) sub-carriers.

43. The electronic device according to claim 34, wherein said transceiver entity is further configured to receive said allocation table on a common channel and said field on a dedicated channel.

44. The electronic device according to claim 34, wherein said dedicated channel comprises said at least one transmission resource.

45. A radio access subsystem for communicating with at least one user station (610,640), the subsystem further comprising:
a control entity (604,654) configured to determine the number of sharing user stations among said at least one user station (610,640) that share a set (505) of transmission resources (504), to determine a combination of transmission resource allocation sizes (452) corresponding to the requirements of each said sharing user station (610,640);
a transceiver entity (602,658) configured to transmit to said at least one user station (610,640) an allocation table (300) wherein said sharing user stations (610,640) are identified in an order corresponding to the transmission resource allocation sizes for each said sharing user station (610,640), and to transmit to said at least one user station (610,640) a field identifying said combination of transmission resource allocation sizes (452).

46. A computer program comprising code adapted to perform the following steps when executed on a data-processing system:
determining the number of sharing user stations that share a set of transmission resources;
determining a combination of transmission resource allocation sizes corresponding to the requirements of each said sharing user station;
transmitting to said user stations an allocation table wherein said sharing user stations are identified in an order corresponding to the transmission resource allocation sizes for each said sharing user station; and
transmitting to said user stations a field identifying said combination of transmission resource allocation sizes.

47. The computer program according to claim 46, wherein said computer program is stored on a computer readable medium.

48. The computer program according to claim 47, wherein said computer readable medium is a removable memory card.

49. The computer program according to claim 47, wherein said computer readable medium is a magnetic or an optical disk.

50. A computer program comprising code adapted to perform the following steps when executed on a data-processing system:
receiving an allocation table wherein at least one user station is identified in an order corresponding to the transmission resource allocation sizes for each at least one user station;
determining the position of a first user station in said allocation table and the number of other identified users;
receiving a field identifying a combination of transmission resource allocation sizes; and
determining the transmission resources of said first user station using said position, said number other identified user stations and said combination of transmission resource allocation sizes.

51. The computer program according to claim 50, wherein said computer program is stored on a computer readable medium.

52. The computer program according to claim 51, wherein said computer readable medium is a removable memory card.

53. The computer program according to claim 52, wherein said computer readable medium is a magnetic or an optical disk.
